(19) United States
(12) Patent Application Publication
(10) Pub. No.: US 2025/0094971 A1
(43) Pub. Date: Mar. 20, 2025

(54) ARTIFICIAL INTELLIGENCE-BASED METHODS AND SYSTEMS FOR GENERATING OPTIMAL EMBEDDINGS FOR IDENTIFYING SIMILAR ENTITIES

(71) Applicant: MASTERCARD INTERNATIONAL INCORPORATED, Purchase, NY (US)

(72) Inventors: Gaurav Oberoi, Uttar Pradesh (IN); Pranav Poduval, Uttar Pradesh (IN); FNU Karamjit Singh, White Plains, NY (US)

(73) Assignee: MASTERCARD INTERNATIONAL INCORPORATED, Purchase, NY (US)

(21) Appl. No.: 18/471,060

(22) Filed: Sep. 20, 2023

(51) Int. Cl. G06Q 20/38; G06Q 20/32; G06Q 20/42

(52) U.S. Cl. CPC G06Q 20/389; G06Q 20/325; G06Q 20/42

(57) ABSTRACT

Methods and server systems for performing similarity-search are described herein. Method performed by server system includes accessing entity-related dataset and using that generating set of entity-specific features including subset of numerical features and subset of categorical features corresponding to each of plurality of entities. Method includes determining label corresponding to each of plurality of entities based on subset of categorical features. Method includes generating via first model, first set of entity-specific embeddings corresponding to each of plurality of entities based on corresponding subset of numerical features and corresponding label. Method includes generating via second model, second set of entity-specific embeddings corresponding to each of plurality of entities based on corresponding subset of categorical features and corresponding first set of entity-specific embeddings, further generating set of optimal embeddings corresponding to each of plurality of entities based on concatenating corresponding first set of entity-specific embeddings and corresponding second set of entity-specific embeddings.

### TECHNICAL FIELD

The present disclosure relates to artificial intelligence-based processing systems and, more particularly, to electronic methods and complex processing systems for generating optimal embeddings for identifying similar entities from a plurality of entities.

### BACKGROUND

Within the financial sector, there is an ever-increasing number of merchants, cardholders, issuing banks, and acquiring banks. Further, due to the digitalization of the financial sector, most of the financial transactions within the payment eco-system are settled digitally. Examples of digitally settled transactions include transactions settled via electronic transfer of funds or payment instruments such as payment cards, online payments for goods and services, and the like. As may be understood, the transaction data (or merchant-cardholder interaction data) is generally recorded for all such digital payment transactions. This transaction data can be leveraged to perform a variety of tasks. One such task is known as a similarity search. The term ‘similarity search’ refers to a search for similar entities within a network. In the present context, ‘similarity search’ refers to a search of similar cardholders, merchants, acquirers, and issuers. In various implementations, similarity search is used to perform a variety of tasks such as peer-set generation, recommendation generation, community detection, anomaly (or fraud) detection, and the like. It is noted that similarity search is a vital problem that needs to be solved within the payment eco-system. In order to address this problem, various techniques have been developed.

One such technique for performing a similarity search is based on a rule-based approach. In this technique, various rules are used to differentiate between different merchants, and thus, similar merchants are determined based on this differentiation. For example, a rule may segregate merchants based on shared customers, i.e., all potentially similar merchants are determined based on transactions performed by the same cardholders (in other words, customers) across them. Another rule may segregate merchants based on their proximity to each other, i.e., all potentially similar merchants will be located in the same region or in close proximity to each other. Yet another rule may segregate merchants based on their industry, i.e., all potentially similar merchants will belong to the same industry. As may be understood, this rule-based technique may be implemented using a variety of Artificial Intelligence (AI) or Machine Learning (ML) based algorithms as well. However, it should be noted that such a rule approach for performing a similarity search suffers from a variety of disadvantages, e.g., this approach has a low coverage due to the hard-coded rules, it is computationally expensive, and the similar merchant set (known as ‘peer set’) determined using this technique is sub-optimal, i.e., it is not always accurate.

Another technique for performing a similarity search is based on using Graph Neural Network (GNN) algorithms or models that learn from the transaction data to classify the plurality of entities based on their similarity to each other. In particular, the GNN models are used for generating node embeddings from entities such as merchants, which can be further used to generate a graph to which rules can be applied to similar entities for a particular entity. However, it is noted that most of the real-world transaction data have a plurality of high cardinality categorical features such as city, industry, super-industry, and the like which have converted into different features (that are later represented in low-dimensional space as embeddings) via a variety of encoding techniques such as one-hot encoding and fed to the GNNs to train them. As may be understood, the existing GNN algorithms or models are not designed to work on such sparse features therefore, it becomes difficult for such GNNs to learn these sparse features while preserving embeddings associated with them. In other words, conventional GNN algorithms or models are not able to utilize or learn from sparse features (i.e., high-cardinality categorical features) and thus, are unable to preserve the embeddings associated with them. This leads to the conventional GNNs having poor performance while performing the similarity search.

Thus, there exists a technological need for technical solutions for improving the existing GNN-based model's ability to generate embeddings for a plurality of entities to improve their performance while performing similarity searches.

### SUMMARY

Various embodiments of the present disclosure provide methods and systems for generating a set of optimal embeddings corresponding to each of a plurality of entities and performing similarity searches based on these optimal embeddings.

In an embodiment, a computer-implemented method for generating a set of optimal embeddings corresponding to each of a plurality of entities is disclosed. The computer-implemented method performed by a server system includes accessing an entity-related dataset from a database associated with the server system. The entity-related dataset includes information related to a plurality of entities. Further, the method includes generating a set of entity-specific features corresponding to each of the plurality of entities based, at least in part, on the entity-related dataset. The entity-specific features include a subset of numerical features and a subset of categorical features. Further, the method includes determining a label corresponding to each of the plurality of entities based, at least in part, on the subset of categorical features. Further, the method includes generating via a first machine learning model, a first set of entity-specific embeddings corresponding to each of the plurality of entities based, at least in part, on the corresponding subset of numerical features and the corresponding label. Further, the method includes generating via a second machine learning model, a second set of entity-specific embeddings corresponding to each of the plurality of entities based, at least in part, on the corresponding subset of categorical features and the corresponding first set of entity-specific embeddings. Further, the method includes generating a set of optimal embeddings corresponding to each of the plurality of entities based, at least in part, on concatenating the corresponding first set of entity-specific embeddings and the corresponding second set of entity-specific embeddings.

In another embodiment, a server system is disclosed. The server system includes a communication interface and a memory including executable instructions. The server system also includes a processor communicably coupled to the memory. The processor is configured to execute the instructions to cause the server system, at least in part, to access an entity-related dataset from a database associated with the server system. The entity-related dataset includes information related to a plurality of entities. Further, the server system is caused to generate a set of entity-specific features corresponding to each of the plurality of entities based, at least in part, on the entity-related dataset. The entity-specific features include a subset of numerical features and a subset of categorical features. Further, the server system is caused to determine a label corresponding to each of the plurality of entities based, at least in part, on the subset of categorical features. Further, the server system is caused to generate via the first machine learning model, a first set of entity-specific embeddings corresponding to each of the plurality of entities based, at least in part, on the corresponding subset of numerical features and the corresponding label. Further, the server system is caused to generate via a second machine learning model, a second set of entity-specific embeddings corresponding to each of the plurality of entities based, at least in part, on the corresponding subset of categorical features and the corresponding first set of entity-specific embeddings. Further, the server system is caused to generate a set of optimal embeddings corresponding to each of the plurality of entities based, at least in part, on concatenating the corresponding first set of entity-specific embeddings and the corresponding second set of entity-specific embeddings.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing an entity-related dataset from a database associated with the server system. The entity-related dataset includes information related to a plurality of entities. Further, the method includes generating a set of entity-specific features corresponding to each of the plurality of entities based, at least in part, on the entity-related dataset. The entity-specific features include a subset of numerical features and a subset of categorical features. Further, the method includes determining a label corresponding to each of the plurality of entities based, at least in part, on the subset of categorical features. Further, the method includes generating via a first machine learning model, a first set of entity-specific embeddings corresponding to each of the plurality of entities based, at least in part, on the corresponding subset of numerical features and the corresponding label. Further, the method includes generating via a second machine learning model, a second set of entity-specific embeddings corresponding to each of the plurality of entities based, at least in part, on the corresponding subset of categorical features and the corresponding first set of entity-specific embeddings. Further, the method includes generating a set of optimal embeddings corresponding to each of the plurality of entities based, at least in part, on concatenating the corresponding first set of entity-specific embeddings and the corresponding second set of entity-specific embeddings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates a block diagram representation of an exemplary process for transforming or reducing a bipartite graph into a homogeneous entity graph, in accordance with an embodiment of the present disclosure;

FIG. 4. illustrates a schematic representation of the iterative process performed by a first machine learning model and a second machine learning model on a homogeneous entity graph, in accordance with an embodiment of the present disclosure;

FIGS. 5A, 5B, 5C, and 5D, are plotted representations depicting experimental results of various experiments performed, in accordance with one or more embodiments of the present disclosure;

FIG. 6 illustrates a process flow diagram depicting a method for generating a set of optimal embeddings corresponding to each of a plurality of entities, in accordance with the present disclosure;

FIG. 7 illustrates a simplified block diagram of an acquirer server, in accordance with an embodiment of the present disclosure;

FIG. 8 illustrates a simplified block diagram of an issuer server, in accordance with an embodiment of the present disclosure; and

FIG. 9 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by such as Mastercard®.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point Of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, user devices, and computer program products for generating a set of optimal embeddings corresponding to each of a plurality of entities and performing similarity searches based on these optimal embeddings.

In an embodiment, a server system that may be a payment server associated with a payment network is configured to access an entity-related dataset from a database associated with the server system. Herein, the entity-related dataset includes information related to a plurality of entities. In an example, the entity-related dataset is a historical transaction dataset such that the historical transaction dataset includes information related to a plurality of historical payment transactions performed between a plurality of cardholders and a plurality of merchants. In various non-limiting examples, the plurality of entities is one of a plurality of merchants, a plurality of cardholders, a plurality of issuers, and a plurality of acquirers.

In another embodiment, the server system is configured to generate a set of entity-specific features corresponding to each of the plurality of entities based, at least in part, on the entity-related dataset. In particular, the entity-specific features include a subset of numerical features and a subset of categorical features. Further, the server system is configured to determine a label corresponding to each of the plurality of entities based, at least in part, on the subset of categorical features.

In another embodiment, the server system is configured to generate via a first machine learning model, a first set of entity-specific embeddings corresponding to each of the plurality of entities based, at least in part, on the corresponding subset of numerical features and the corresponding label. In particular, generating the first set of entity-specific embeddings further includes at first, extracting a set of important features from the subset of numerical features based, at least in part, on a task and a set of pre-defined rules. Then, the server system is configured to compute or calculate a new set of weights for each of the plurality of entities based, at least in part, on adjusting weights associated with the set of important features. Thereafter, the server system is configured to generate via the first machine learning model, the first set of entity-specific embeddings based, at least in part, on the corresponding new set of weights calculated for each of the plurality of entities and the corresponding label.

In another embodiment, the server system is configured to generate via a second machine learning model, a second set of entity-specific embeddings corresponding to each of the plurality of entities based, at least in part, on the corresponding subset of categorical features and the corresponding first set of entity-specific embeddings. In particular, for generating the second set of entity-specific embeddings, the server system is configured to at first generate a set of intermediate entity-specific embeddings corresponding to each of the plurality of entities based, at least in part, on the corresponding subset of categorical features. Thereafter, the server system is configured to determine the second set of entity-specific embeddings corresponding to each of the plurality of entities by updating the corresponding set of intermediate entity-specific embeddings based, at least in part, on the corresponding first set of entity-specific embeddings and the subset of categorical features using a self-learning attention process. In various non-limiting examples, the first machine learning model and the second machine learning model may be Graph Neural Network (GNN) based machine learning models.

In another embodiment, the server system is configured to generate a set of optimal embeddings corresponding to each of the plurality of entities based, at least in part, on concatenating the corresponding set of entity-specific embeddings and the corresponding second set of entity-specific embeddings.

In another embodiment, the server system is configured to generate a homogeneous entity graph based, at least in part, on the entity-related dataset and the set of entity-specific features for each of the plurality of entities. Herein, the homogeneous entity graph includes a plurality of nodes such that each of the plurality of nodes corresponds to each of the plurality of entities. Such that each of the plurality of nodes includes the corresponding set of entity-specific features.

In another environment, the server system is configured to generate an entity-specific graph based, at least in part, on the set of optimal embeddings corresponding to each of the plurality of entities. Further, the server system is configured to determine a similarity range for an entity from the plurality of entities based, at least in part, on a task. Then, the server system is configured to generate a peer set for the entity based, at least in part, on the entity-specific graph, and the similarity range. Herein, the peer set indicates a set of entities from the entity-specific graph within the similarity range of the entity.

Various embodiments of the present disclosure provide multiple advantages and technical effects while addressing technical problems such as how to improve the existing GNN algorithms which are not designed to work on categorical features with high cardinality known as sparse features while preserving the embeddings associated with them thereby improving the performance of the similarity search performed using these embeddings. To that end, the various embodiments of the present disclosure provide an approach for generating a set of optimal embeddings while preserving the embeddings generated from the categorical features. For instance, the server system utilizes labels generated based on the corresponding subset of categorical features along with the corresponding subset of numerical features for generating a first set of entity-specific embeddings corresponding to each of the plurality of entities. As may be understood, this aspect of the present disclosure allows for a direct flow of gradient towards optimizing the subset of categorical features within the first machine learning model. In other words, using these labels along with the subset of numerical data for generating the first set of entity-specific embeddings allows the first machine model to preserve the categorical information within the entity-specific embeddings thus generated.

Further, it should be noted that the second machine learning model uses the first set of entity-specific embeddings along with the subset of categorical features for generating the second set of entity-specific embeddings. This aspect of the present disclosure allows the second machine model to implement a self-attention process (or mechanism) which further allows the second machine learning model to focus on the sparse features (i.e., categorical features). Then, learn from any complex information that was missed by the first machine learning model. Further, the set of optimal embeddings generated for each of the plurality of entities is generated by concatenating the corresponding first set of entity-specific embeddings and the corresponding second set of entity-specific embeddings. Further, it is noted that using this set of optimal embeddings, an entity-specific graph is generated for each of the plurality of entities which is then used to generate the peer set results in a peer set that is more accurate and precise compared to those generated using conventional techniques.

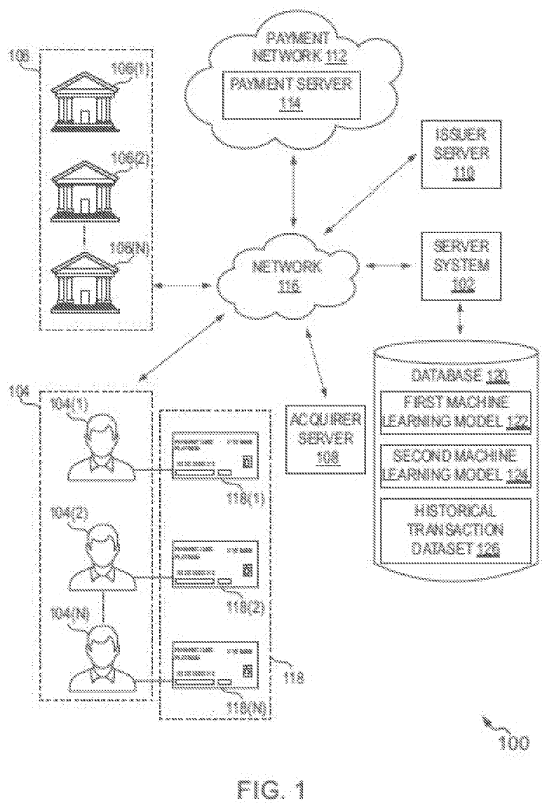

Various embodiments of the present disclosure are described hereinafter with reference to FIGS. 1 to 9.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining a set of optimal embeddings corresponding to each of the plurality of entities within a network, generating entity-specific graphs, generating a peer set that indicates similar entities from the plurality of entities, and the like.

The environment 100 generally includes a plurality of entities such as a server system 102, a plurality of cardholders 104(1), 104(2), . . . 104(N) (collectively, referred to as a plurality of cardholders 104 and ‘N’ is a Natural number), a plurality of merchants 106(1), 106(2), . . . 106(N) (collectively, referred to as a plurality of merchants 106 and ‘N’ is a Natural number), an acquirer server 108, an issuer server 110, and a payment network 112 including a payment server 114, each coupled to, and in communication with (and/or with access to) a network 116. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the acquirer server 108, the issuer server 110, and the payment server 114 may communicate.

In an embodiment, the plurality of cardholders 104 use one or more payment cards 118(1), 118(2), . . . 118(N) (collectively, referred to hereinafter as a plurality of payment cards 118 and ‘N’ is a Natural number) respectively to make payment transactions. The cardholder (e.g., the cardholder 104(1)) may be any individual, representative of a corporate entity, anon-profit organization, or any other person who is presenting payment account details during an electronic payment transaction. The cardholder (e.g., the cardholder 104(1)) may have a payment account issued by an issuing bank (not shown in figures) associated with the issuer server 110 (explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank.

In an example, the plurality of cardholders 104 may use their corresponding electronic devices (not shown in figures) to access a mobile application or a website associated with the issuing bank, or any third-party payment application. In various non-limiting examples, the electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the plurality of merchants 106 may include retail shops, restaurants, supermarkets or establishments, government and/or private agencies, or any such places equipped with POS terminals, where a cardholder such as a cardholder 104(1) visits for performing the financial transaction in exchange for any goods and/or services or any financial transactions.

In one scenario, the plurality of cardholders 104 may use their corresponding payment accounts to conduct payment transactions with the plurality of merchants 106. Moreover, it may be noted that each of the plurality of cardholders 104 may use their corresponding payment card (such as payment card 118(1)) from the plurality of payment cards 118 differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card 118(2) to perform an offline payment transaction. It is understood that generally, the term “payment transaction” refers to an agreement that is carried out between a buyer and a seller to exchange goods or services in exchange for assets in the form of a payment (e.g., cash, fiat-currency, digital asset, cryptographic currency, coins, tokens, etc.). For example, the cardholder 104(3) may enter details of the payment card 118(3) to transfer funds in the form of fiat currency on an e-commerce platform to buy goods. In another instance, each cardholder (e.g., the cardholder 104(1)) of the plurality of cardholders 104 may transact at any merchant (e.g., the merchant 106(1)) from the plurality of merchants 106.

In one embodiment, the plurality of cardholders 104 may be associated with the issuer server 110. In one embodiment, the issuer server 110 is associated with a financial institution normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the plurality of merchants 106 is associated with the acquirer server 108. In an embodiment, each merchant (e.g., the merchant 106(1)) is associated with an acquirer server (e.g., the acquirer server 108). In one embodiment, the acquirer server 108 is associated with a financial institution (e.g., a bank) that processes financial transactions for the merchant 106(1). This can be an institution that facilitates the processing of payment transactions for physical stores, merchants (e.g., the merchant 106(1)), or institutions that own platforms that make either online purchases or purchases made via software applications possible (e.g., shopping cart platform providers and in-app payment processing providers). The terms “acquirer”, “acquiring bank”, “acquiring bank” or “acquirer server 108” will be used interchangeably herein.

As explained earlier, the similarity search problem is conventionally addressed using GNN-based models. However, these conventional models are unable to learn from the spare features or the high cardinality categorical features which reduces the performance of such models while executing a similarity search. More specifically, it is noted that transaction data can be broadly classified into numerical data and categorical data. These data can be converted to feature representations (i.e., numerical features and categorical features) using various techniques such as one-hot encoding, entity encoding, and the like. In various non-limiting examples, the numerical features related to the plurality of merchants 106 may include at least average ticket price, average ticket price, total sales volume, an average spent per card, for the last 1 week, 1 month, 3 months, and the like. Similarly, in various non-limiting examples, the categorical features related to the plurality of merchants 106 may include merchant coordinates (i.e., latitude and longitude of the merchant), merchant industry, merchant super-industry, Merchant Category Code (MCC), and the like. It should be understood that numerical and categorical features pertaining to each of the plurality of entities in the payment network 112 may be different from each other and merchant-related features are just provided herein as an example. In other words, search similarity can be performed for any of the entities in the payment network 112.

It should be understood that each of the categorical features has a high cardinality, i.e., each of these features can have various possible values. For example, each of the plurality of merchants 106 may belong to different industries such as petrochemical, retail, and the like, therefore the industry feature has various possible values depending on the plurality of merchants 106. The categorical features are also known as sparse features since these features mostly have zero values. For example, one-hot encodings generated for categorical data will lead to categorical features with mostly zero values. Therefore, the categorical features are also referred to as sparse features. As described earlier, the existing GNN algorithms are not designed to work on such sparse features therefore, it becomes difficult for such GNNs to learn these sparse features while preserving embeddings (that are generated by the GNN model) associated with them. In other words, conventional GNNs are not able to utilize or learn from sparse features (i.e., high-cardinality categorical features) and thus, are unable to preserve the embeddings associated with them. This leads to the conventional GNNs having poor performance while performing the similarity search.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 120 coupled with the server system 102. In an example, the server system 102 coupled with the database 120 is embodied within the payment server 114, however, in other examples, the server system 102 can be a standalone component (acting as a hub) connected to the acquirer server 108 and the issuer server 110. The database 120 may be incorporated in the server system 102 or maybe an individual entity connected to the server system 102 or maybe a database stored in cloud storage. In one embodiment, the database 120 may store a first machine learning model 122, a second machine learning model 124, a historical transaction dataset 126, and other necessary machine instructions required for implementing the various functionalities of the server system 102 such as firmware data, operating system and the like.

In an example, the database 120 stores the historical transaction dataset 126 which may also include real-time transaction data of the plurality of cardholders 104 and the plurality of merchants 106. To that end, the transaction data may also be called merchant-cardholder interaction data as well. The transaction data may include, but is not limited to, transaction attributes, such as transaction amount, source of funds such as bank or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

It is noted that the transaction data can be broadly classified into numerical data/parameters and categorical data/parameters. This numerical data and categorical data may be transformed into numerical features and categorical features using conventional techniques such as one-hot encoding, entity-embeddings, and the like, and stored within the database 120 within the historical transaction dataset 126. It is noted that in the present disclosure, the process of transforming the data into features can be performed using conventional or known techniques and therefore, the same is not explained herein for the sake of brevity. To that end, the historical transaction dataset 126 includes corresponding numerical features for each of the plurality of entities within the payment network 112 and corresponding categorical features for each of the plurality of entities within the payment network 112.

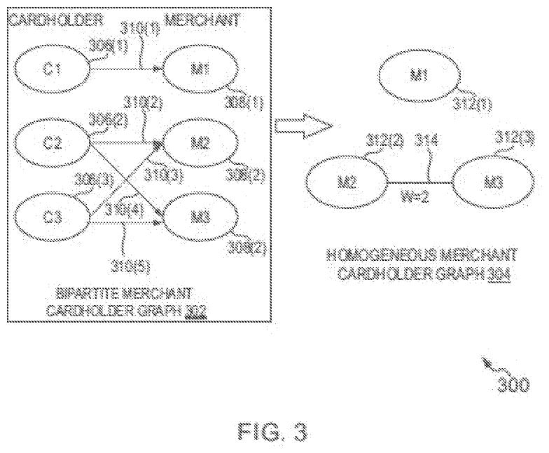

In another example, the first machine learning model 122 and the second machine learning model 124 are AI or ML based models that are configured or trained to perform a plurality of operations. In a non-limiting example, the first machine learning model 122 and the second machine learning model 124 can be GNN-based models. It is noted that the models have been explained in detail later in the present disclosure with reference to FIG. 3. In addition, the database 120 provides a storage location for data and/or metadata obtained from various operations performed by the server system 102.

In an embodiment, the server system 102 is configured to access a historical transaction dataset 126 from a database such as database 120 associated with the server system 102. It is noted that the historical transaction dataset 126 includes information related to a plurality of entities within the payment network 112. As described earlier, the historical payment transaction dataset 126 includes information related to a plurality of historical payment transactions performed between the plurality of cardholders 104 and the plurality of merchants 106. Then, the server system 102 is configured to generate a set of entity-specific features corresponding to each entity of the plurality of entities based, at least in part, on the historical transaction dataset 126. In a non-limiting example, the entity-specific features may include a subset of numerical features and a subset of categorical features. For instance, for each of the plurality of merchants 106, the merchant-specific features will include a corresponding subset of numerical features for each of the plurality of merchants 106 and a corresponding subset of categorical features for each of the plurality of merchants 106.

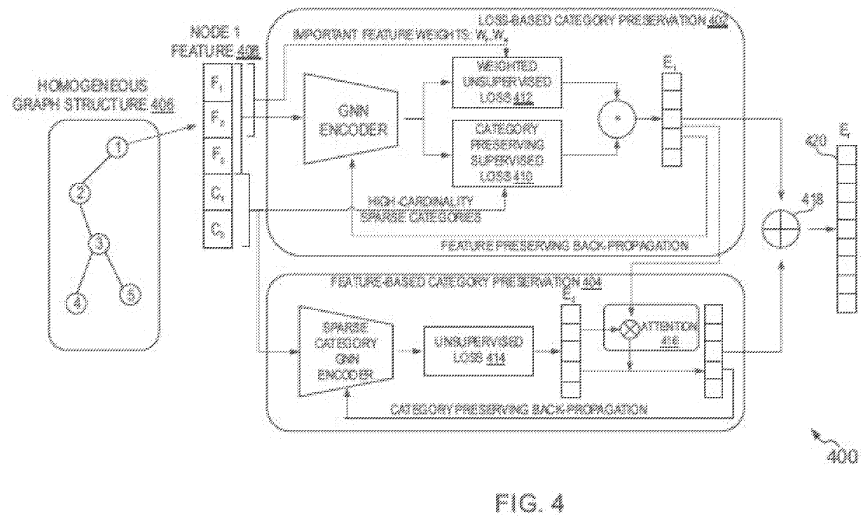

Thereafter, the server system 102 is configured to determine a label corresponding to each of the plurality of entities based, at least in part, on the subset of categorical features. Further, the server system 102 is configured to generate a first set of entity-specific embeddings corresponding to each of the plurality of entities based, at least in part, on the corresponding subset of numerical features and the corresponding label. In various non-limiting examples, one or more AI or ML models for generating the first set of entity-specific embeddings corresponding to each of the plurality of entities. In a non-limiting example, the first machine learning model 122 may be used for generating the first set of entity-specific embeddings corresponding to each of the plurality of entities. It is understood that using the labels generated based on the subset of categorical features allows for a direct flow of gradient towards optimizing the subset of categorical features within the first machine learning model 122. In other words, using these labels along with the subset of numerical data for generating the first set of entity-specific embeddings allows the first machine model 122 to preserve the categorical information within the embeddings thus, generated. It is noted that this aspect has been explained further in detail later with reference to FIG. 4.

Thereafter, the server system 102 is configured to generate a second set of entity-specific embeddings corresponding to each of the plurality of entities based, at least in part, on the corresponding subset of categorical features and the corresponding first set of entity-specific embeddings. In various non-limiting examples, one or more AI or ML models for generating the second set of entity-specific embeddings corresponding to each of the plurality of entities. In a non-limiting example, the second machine learning model 124 may be used for generating the second set of entity-specific embeddings corresponding to each of the plurality of entities.

It is understood that using the first set of entity-specific embeddings along with the subset of categorical features allows the second machine learning model 124 to implement a self-attention process or self-attention mechanism which further allows the second machine learning model 124 to focus on the sparse features (i.e., categorical features) and learn from any complex information that was missed by the first machine learning model 122 during the learning process. It is noted that this aspect has been explained further in detail later with reference to FIG. 4.

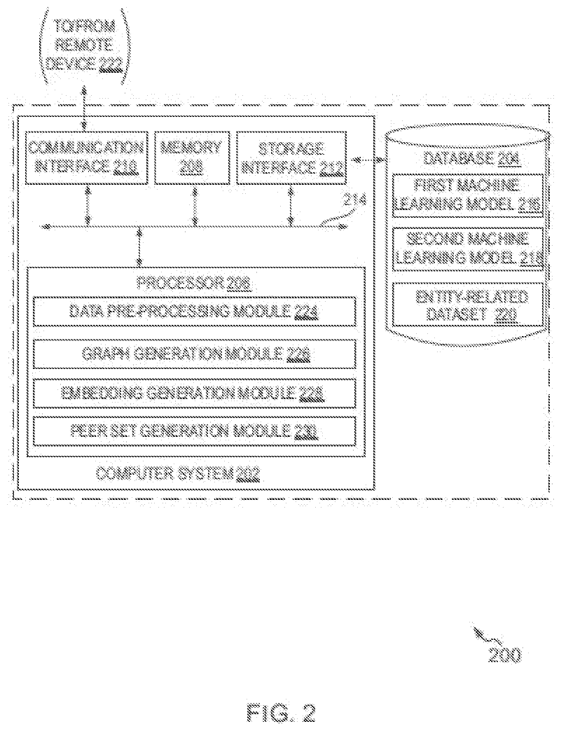

Furthermore, the server system 102 is configured to generate a set of optimal embeddings corresponding to each of the plurality of entities based, at least in part, on concatenating the corresponding first set of entity-specific embeddings and the corresponding second set of entity-specific embeddings. Thereafter, the server system 102 may be configured to perform other operations as well, these operations along with the operations described earlier and explained further in detail with reference to FIG. 2.

In one embodiment, the payment network 112 may be used by the payment card issuing authorities as a payment interchange network. Examples of the plurality of payment cards 118 include debit cards, credit cards, etc. Similarly, examples of payment interchange networks include but are not limited to, a Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

FIG. 2 illustrates a simplified block diagram of a server system 200, in accordance with an embodiment of the present disclosure. It is noted that the server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (SaaS) based architecture.

The server system 200 includes a computer system 202 and a database 204. It is noted that the database 204 is identical to the database 120 of FIG. 1. The computer system 202 includes at least one processor 206 (herein, referred to interchangeably as ‘processor 206’) for executing instructions, a memory 208, a communication interface 210, and a storage interface 212 that communicates with each other via a bus 214.

In some embodiments, the database 204 is integrated into the computer system 202. For example, the computer system 202 may include one or more hard disk drives as the database 204. A storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a first machine learning model 216, a second machine learning model 218, an entity-related dataset 220, and the like. It is noted that the first machine learning model 216 and the second machine learning model 218 are identical to the first machine learning model 122 and the second machine learning model 124 of FIG. 1. Further, it is noted that the historical transaction dataset 126 of FIG. 1 is a possible example for the entity-related dataset 220.

As may be understood, although the various embodiments of the invention described herein are explained with the help of examples from the payment ecosystem, the same should not be construed as a limitation and other suitable implementations of the novel approach described herein can be applied to other technical fields as well such as, but not limited to, image processing, medical industry and the like. To that end, although the entity-related dataset 220 is considered to include transaction-related data for a financial sector-related implementation, the same may also include image-related data, medical records-related data, and the like based on suitable applications/implementations.

The processor 206 includes suitable logic, circuitry, and/or interfaces to execute operations for determining a set of optimal embeddings corresponding to each of the plurality of entities within a network, generating entity-specific graphs, generating a peer set that indicates similar entities from the plurality of entities and the like. In other words, the processor 206 includes suitable logic, circuitry, and/or interfaces to execute operations for generating a peer set indicating similar entities from the plurality of entities and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 222 such as the acquirer server 108, the issuer server 110, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 224, a graph generation module 226, an embedding generation module 228, and a peer set generation module 230. It should be noted that components, described herein, such as the data pre-processing module 224, the graph generation module 226, the embedding generation module 228 and, the peer set generation module 230 can be configured in a variety of ways, including electronic circuitries, digital arithmetic, and logic blocks, and memory systems in combination with software, firmware, and embedded technologies.

In an embodiment, the data pre-processing module 224 includes suitable logic and/or interfaces for accessing an entity-related dataset such as the entity-related dataset 220 from a database such as the database 204 associated with the server system 200. In particular, the entity-related dataset 220 may at least include information related to a plurality of entities. In one non-limiting example, the plurality of entities may include the plurality of cardholders 104, the plurality of merchants 106, a plurality of issuer servers (such as computing servers similar to the issuer server 110 depicted in FIG. 1), and a plurality of acquirer servers (such as computing servers similar to the acquirer server 108 depicted in FIG. 1). Further, the information related to these entities may include information related to a plurality of historical payment transactions performed by the plurality of cardholders 104 with the plurality of merchants 106. It is noted that this non-limiting example is specific to the financial industry or payment ecosystem. To that end, the entity-related dataset 220 can be configured to include different information specific to any field of operation. Therefore, it is understood that the various embodiments of the present disclosure apply to a variety of different fields of operation and the same is covered within the scope of the present disclosure.

Returning to the example, the plurality of historical payment transactions may be performed within a predetermined interval of time (e.g., 6 months, 12 months, 24 months, etc.).

In some other non-limiting examples, the entity-related dataset 220 includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), merchant database (DBA) name, country code, transaction identifier, transaction amount, and the like.

In one example, entity-related dataset 220 may define a relationship between each of the plurality of entities. In a non-limiting example, a relationship between a cardholder account and a merchant account by the entity-related dataset 220. For example, it is understood that when a cardholder such as cardholder 104(1) purchases an item from a merchant such as merchant 106(1), a relationship is established.

In another embodiment, the entity-related dataset 220 may include information related to past payment transactions such as transaction date, transaction time, geo-location of a transaction, transaction amount, transaction marker (e.g., fraudulent or non-fraudulent), and the like. In yet another embodiment, the entity-related dataset 220 may include information related to the acquirer server 108 such as the date of merchant registration with the acquirer server 108, amount of payment transactions performed at the acquirer server 108 in a day, number of payment transactions performed at the acquirer server 108 in a day, maximum transaction amount, minimum transaction amount, number of fraudulent merchants or non-fraudulent merchants registered with the acquirer server 108, and the like.

In addition, the data pre-processing module 224 is configured to generate a set of entity-specific features corresponding to each of the plurality of entities based, at least in part, on the entity-related dataset 220. More specifically, it is understood that the information related to the plurality of entities present within the entity-related dataset 220 can be broadly classified as numerical data and categorical data. The data pre-processing module 224 is configured to generate a subset of numerical features and a subset of categorical features based, at least in part, on the numerical data and the categorical data, respectively. In various non-limiting examples, the data pre-processing module 224 may utilize any feature or embedding generation approach such as, but not limited to, one-hot embedding, entity-embeddings, and the like to generate the set of entity-specific features. It is understood that such features and embedding generation techniques are already known in the art, therefore the same are explained here for the sake of brevity.

In another embodiment, the data pre-processing module 224 is communicably coupled to the graph generation module 226 and is configured to transmit the set of entity-specific features to the graph generation module 226.

In an embodiment, the graph generation module 226 includes suitable logic and/or interfaces for generating a homogeneous entity graph-based, at least in part, on the entity-related dataset 220 and the set of entity-specific features for each of the plurality of entities. In an example, the homogeneous entity graph may include at least a plurality of nodes such that each of the plurality of nodes corresponds to each of the plurality of entities. Further, it is noted that each of the plurality of nodes includes at least the set of entity-specific features. More specifically, at first, the set of entity-specific features is fed to the graph generation module 226 along with the entity-related dataset 220. Then, the graph generation module 226 determines one or more features required for the generation of the graph by analyzing the information related to the plurality of entities included in the entity-related dataset 220. For instance, the one or more features corresponding to each entity may be included in a node and the nodes may be connected with one or more edges. Herein, the one or more edges may define the relationship between different entities of the plurality of entities. In a non-limiting example, the graph generation module 226 identifies the cardholders 104(3)-104(6) that have made payment transactions with the merchants 106(4)-106(8) based at least on the information related to historical payment transactions between the plurality of cardholders 104 and the plurality of merchants 106. More specifically, at first, a cardholder-merchant bipartite graph may be generated. Then, the cardholder-merchant bipartite graph may be simplified to generate the homogeneous entity graph for either the plurality of cardholders 104 or the plurality of merchants 106. Upon reducing the bipartite graph to the homogeneous entity graph, the graph generation module 226 determines a first set of the one or more nodes as the plurality of entities for which the homogeneous entity graph is generated with the one or more edges indicating the relationship between the plurality of entities as one or more edges. For instance, a merchant-cardholder bipartite graph may be reduced to a homogeneous merchant graph where each node represents a different merchant and the edges indicate the number of cardholders that are shared in common between two different merchants (i.e., how many common cardholders have performed transactions at the two different merchants). It is noted that the generation of the homogeneous entity graph has been explained further in detail later in the present disclosure with reference to FIG. 3.

In another embodiment, the graph generation module 226 is communicably coupled to the embedding generation module 228 and is configured to transmit the homogeneous entity graph to the embedding generation module 228.

In an embodiment, the embedding generation module 228 includes suitable logic and/or interfaces for determining a label corresponding to each of the plurality of entities based, at least in part, on the subset of categorical features.

In another embodiment, the embedding generation module 228 is configured to generate a first set of entity-specific embeddings corresponding to each of the plurality of entities based, at least in part, on the corresponding subset of numerical features and the corresponding label. In one implementation, the embedding generation module 228 is configured to generate the first set of entity-specific embeddings using an AI or ML model. In one example, the generation process is done using the first machine learning model 216. In one example, the first machine learning model 216 is a graph neural network (GNN) based machine learning model. In particular, the embedding generation module 228 is configured to at first, extract a set of important features from the subset of numerical features based, at least in part, on a task. The term ‘task’ refers to an operation or application for which the embeddings are generated.

For instance, embeddings may be generated for a variety of tasks such as, but not limited, to understanding the growth of a merchant in a particular product category when compared to its peers, understanding the revenue growth of a merchant when compared to its peers, understanding the fraud rate of a merchant when compared to its peers, understanding fraud rate of a cardholder when compared to its peers, understanding a medical diagnosis of a patient when compared to its peers and the like. It is understood different numerical features play different importance in the generation of embeddings based on a task that is to be performed. For instance, if merchant domestic sales growth of a domestic merchant has to be compared with its peers, then features related to international transactions at the different merchants will not be important. To that end, it is important to distinguish between the relevance or the importance of different features within the subset of numerical features.

It is understood that since the importance of features is subjective and depends on the task to be performed, there needs to be a way to determine which features are important for performing the required task. In various scenarios, the determination of the set of important features can be done based, at least in part, on a set of pre-defined rules. In particular, a team of analysts or an administrator (not shown here for the sake of brevity) of the server system 200 may define this set of predefined rules or logic for either a specific task or a plurality of distinct tasks that may be performed.

Further, the embedding generation module 228 is configured to calculate anew set of weights for each of the plurality of entities based, at least in part, on adjusting weights associated with the set of important features. As may be understood, when the importance of some features is more or less over others, the weights associated with the plurality of entities in the graph, i.e., the homogeneous entity graph are adjusted within the AI or ML algorithm to define the importance/relevance of that feature. It should be noted that these weights are not updated arbitrarily, instead, these weights are updated based on the task for which the embeddings are being generated. In some scenarios, the criteria for increasing the value of weights associated with each of the sets of important features may be based on another set of predefined rules or logic. In particular, a team of analysts or an administrator of the server system 200 (not shown here for the sake of brevity) may define another set of predefined rules or logic for a specific task that needs to be performed. It is noted that by increasing the weights associated with the plurality of entities, the overall performance of the first machine learning model 216 is improved.

Furthermore, the embedding generation module 228 is configured to generate the first set of entity-specific embeddings based, at least in part, on the new set of weights calculated for each of the plurality of entities and the label corresponding to each of the plurality of entities. It is understood that using the labels determined based on the subset of categorical features allows for a direct flow of gradient towards optimizing the subset of categorical features within the first machine learning model 216. In other words, using these labels along with the subset of numerical data for generating the first set of entity-specific embeddings allows the first machine learning model 216 to improve the model performance by preserving the categorical information within the embeddings thus generated. Herein, in an embodiment, the subset of categorical features may be directly used as labels and not as input features. For example, one or more of the categorical features corresponding to a merchant may be an industry of the merchants, a Merchant Category Code (MCC), etc., may be used as a label. For instance, a label derived from the MCC may be “grocery merchant”. On the other hand, the numerical features may be used as input features. Examples of numerical features corresponding to a merchant may include merchant location, transaction statistics, etc. It is noted that this aspect has been explained later in the present disclosure with reference to FIG. 4.

In another embodiment, the embedding generation module 228 is configured to generate a second set of entity-specific embeddings corresponding to each of the plurality of entities based, at least in part, on the subset of categorical features and the first set of entity-specific embeddings corresponding to each of the plurality of entities.

In one implementation, the embedding generation module 228 is configured to determine the second set of entity-specific embeddings using an AI or ML model. In one example, the determination process is done using the second machine learning model 218. In particular, the embedding generation module 228 is configured to at first, generate a set of intermediate entity-specific embeddings corresponding to each of the plurality of entities based, at least in part, on the subset of categorical features corresponding to each of the plurality of entities. Thereafter, the embedding generation module 228 is configured to generate the second set of entity-specific embeddings corresponding to each of the plurality of entities by updating the set of intermediate entity-specific embeddings based, at least in part, on the first set of entity-specific embeddings. As may be understood, this aspect of the embedding generation module 228 helps to implement a self-learning attention process or a self-learning attention mechanism which further allows the second machine learning model 218 to focus on the sparse features (i.e., categorical features) and learn from any complex information that was missed earlier by the first machine learning model 216. Therefore, it may be noted that the second machine learning model 218 learns the second set of entity-specific embeddings by using the subset of categorical features, the first set of entity-specific embeddings, and the self-learning attention process. In other words, the second machine learning model 218 learns the second set of entity-specific embeddings by giving more importance to some embeddings from the first set of entity-specific embeddings by using the subset of categorical features corresponding to each of the plurality of entities as the self-learning attention mechanism. In one example, the second machine learning model 218 is a Graph Neural Network (GNN) based machine learning model. It is noted that this aspect has been explained later in the present disclosure with reference to FIG. 4.

In another embodiment, the embedding generation module 228 is configured to generate, a set of optimal embeddings corresponding to each of the plurality of entities based, at least in part, on concatenating the first set of entity-specific embeddings and the second set of entity-specific embeddings. The term ‘concatenation’ refers to the joining or junction of the embeddings in succession. In other words, it may be understood that the set of optimal embeddings can be defined as a super space of two different subspaces (i.e., the first set of entity-specific embeddings and the second set of entity-specific embeddings) in the vector domain. For instance, if a first embedding is of dimension ‘128’ and a second embedding is also of dimension ‘128’, then upon concatenating the first and second embeddings, a final embedding of dimension ‘256’ will be generated.

In another embodiment, the embedding generation module 228 is communicably coupled to the peer set generation module 230 and is configured to transmit the set of optimal embeddings to the peer set generation module 230.

In an embodiment, the peer set generation module 230 includes suitable logic and/or interfaces for generating an entity-specific graph based, at least in part, on the set of optimal embeddings corresponding to each of the plurality of entities. It is noted that the entity-specific graph includes a plurality of nodes corresponding to the plurality of entities. More specifically, each node of the entity-specific graph includes the set of optimal embeddings corresponding to each of the plurality of entities. To that end, the plurality of nodes corresponds to a plurality of sets of optimal embeddings corresponding to the plurality of entities. Furthermore, the plurality of edges connecting the plurality of nodes of the entity-specific graph defines the relation or link between each entity of the plurality of entities. In particular, the distance between two different nodes, i.e., the length of an edge defines the similarity between the two different entities. For instance, if a length of a first edge connecting merchant 106(1) and merchant 106(2) is 2 units in the vector space while a length of a second edge connecting merchant 106(2) and merchant 106(3) is 1 unit. Then, it can be established that merchant 106(2) is more similar to merchant 106(3) than merchant 106(1).

In another embodiment, the peer set generation module 230 is configured to generate a peer set for an entity from the plurality of entities based, at least in part, on the entity-specific graph and a predefined threshold. The peer set indicates a set of entities from the plurality of entities included in the entity-specific graph that is similar to that entity. More specifically, the peer set generation module 230 analyzes the length of edges associated with the plurality of entities in the entity-specific graph to determine the similarity of the plurality of entities with a specific entity. For instance, if the length of the edge extending from the node indicating the specific entity to another node (corresponding to a different entity from the plurality of entities) of the entity-specific graph is lower than the predefined threshold, then this another entity is added to the peer set. Otherwise, if the length of the ledge is greater than a predefined threshold, then this another entity is determined to be dissimilar from the specific entity and is therefore not added to the peer set. This process may be repeated iteratively for each of the plurality of nodes within the entity-specific graph to generate the peer set. As may be understood, the predefined threshold indicates a length of an edge or the distance between two distinct nodes below which the two connecting nodes are determined to be similar to each other. In various non-limiting implementations, the predefined threshold is determined by a team of analysts or an administrator associated with the server system 200 (not shown here for the sake of brevity) specific to the task that needs to be performed using the peer set.

FIG. 3 illustrates a block diagram 300 representation of an exemplary process for transforming or reducing a bipartite graph into a homogeneous entity graph, in accordance with an embodiment of the present disclosure.

As described earlier, the graph generation module 226 of the server system 200 is configured to reduce a merchant-cardholder bipartite graph or bipartite merchant-cardholder graph (see, 302), (hereinafter referred to interchangeably as ‘cardholder-merchant bipartite graph 302’) to generate a homogeneous merchant cardholder graph (see, 304) also known interchangeably as homogeneous merchant cardholder graph 304 (hereinafter referred to interchangeably as ‘homogeneous merchant graph 304’). It is understood that the homogeneous merchant cardholder graph 304 or the homogeneous merchant graph 304 are non-limiting examples of homogeneous entity graphs thus, may be referred to interchangeably as homogeneous entity graph 304 as well. Upon referring to FIG. 3, it is understood that the block diagram 300 includes a cardholder-merchant bipartite graph 302 and a homogeneous merchant graph 304. Further, the cardholder-merchant bipartite graph 302 further includes a plurality of nodes (see, 306(1), 306(2), 306(3), 308(1), 308(2), and 308(3)) connected to each other via a plurality of edges (see, 310(1), 310(2), 310(3), 310(4), and 310(5)). In this example, the nodes 306(1)-306(3) represent a plurality of cardholders (see, C1, C2, and C3) and the nodes 308(1)-308(3) represent a plurality of merchants (see, M1, M2, and M3). It is noted that the plurality of edges 310(1)-310(5) indicates a relationship between the plurality of cardholders C1-C3 and the plurality of merchants M1-M3. Herein, the relationship can be defined as a set of transactions performed between the plurality of cardholders C1-C3 and the plurality of merchants M1-M3.

Further, the homogeneous entity graph 304 further includes a plurality of nodes (see, 312(1), 312(2), and 312(3)) connected to each other via an edge (see, 314). In this example, the plurality of nodes 312(1)-312(3) represent the plurality of merchants (see, M1, M2, and M3) and the edge 314 indicates a relationship between the plurality of merchants M1-M3. Herein, this can be defined as the number of cardholders shared in common between the plurality of merchants M1-M3. Since, in this exemplary homogeneous entity graph 304 two cardholders are common between merchant M2 and merchant M3, the edge can be defined by a length or a weight of 2 i.e., W=2. Further, since only one cardholder is shared in common with merchant M1, there exists no edge between M1 and the other merchants M2 and M3.

In particular, for generating a first entity-second entity bipartite graph, such as a cardholder-merchant bipartite graph 302, cardholder-merchant interaction data (i.e., transaction-related data from the entity-related data 220 such as historical transaction dataset 126) for a specific timeline T to generate a bipartite graph G_{b}=(M, C, E) with M, C representing the plurality of merchants (such as M1-M3), and the plurality of cardholders (such as C1-C3) interacting in the timeline T and E representing the edges or interactions between them. Now, for a merchant mᵢ and cardholder cⱼ in the graph, there exists an edge eᵢⱼ if the cardholder cⱼ transacted with merchant mᵢ during the timeline T.

Now, the graph generation module 226 of the server system 200 is configured to transform G_{b} to a homogeneous merchant graph, G=(M, E′) from G_{b} (it is noted that since the entity for which homogeneous entity graph 304 is generated is a merchant in this example therefore, it is referred to as a homogeneous merchant graph) with M being the set of merchants active during timeline T and E′ being a set of edges. Further, for the merchants mᵢ and mⱼ in the graph G, there exists an edge e′ᵢⱼ if these merchants are connected via more than one merchant-cardholder-merchant (i.e., M-C-M) path in the bipartite graph G_{b}. In other words, edge e′ᵢⱼ will exist if there is more than one cardholder c connecting merchants mᵢ and merchant mⱼ during timeline T.

In another implementation, the graph generation module 226 of the server system 200 can be configured to transform G_{b} by creating a weighted homogeneous Graph, G_{w} with w being the number of M-C-M paths (or the number of common cardholders) and use it to generate the embeddings. In yet another implementation, the graph generation module 226 of the server system 200 can be configured to transform G_{b} by increasing the threshold of a minimum number of M-C-M paths required in G_{b} for an edge to exist between the two merchants in Graph G. This technique can be used to reduce the noise in Graph G and hence the final embeddings while also reducing the computational resources required for performing this transformation.

FIG. 4 illustrates a schematic representation 400 of the iterative process performed by a first machine learning model such as the first machine learning model 216 and a second machine learning model such as the second machine learning model 218 on the homogeneous entity graph, in accordance with an embodiment of the present disclosure.

As may be understood, various techniques can be used to generate merchant embeddings. One such technique is an inductive neighborhood aggregation technique. This technique is based on the assumption that densely connected nodes in a graph are similar to each other and should have similar representations in the embedding space. It should be noted that although the embedding generation is described with respect to this technique however, other techniques may also be used and such techniques will be within the scope of the present disclosure.

For the k^{t} iteration step, for each merchant m∈M, at first the representations of the neighbors [symbol] m are aggregated as [symbol] ₍ₘ₎= [symbol] (hᵤ^{k-1}, ∀u∈ [symbol] (m)) where hᵤ^{k-1} is the representation of node u from the (k−1)^{th} step. Further, [symbol] is an aggregator function that aggregates information about a merchant's local neighborhood. Then, neighborhood aggregation of merchant m, [symbol] ₍ₘ₎ is concatenated with the merchant representation from the previous step hᵤ^{k-1}. Further, the concatenated vector is fed into a fully connected layer with a non-linear activation function σ. Finally, it is normalized to produce the merchant representation for the current step.

It is noted that the aggregator, [symbol] is required to have good representation capacity and symmetric property allowing aggregation arbitrarily over neighborhood merchants. Various aggregators such as but not limited to Mean, STM, Max Pooling, Mean Pooling, and the like may be used as aggregators. In the present implementation, the Mean-Pooling aggregator is used since it has high representation capacity and low aggregation time complexity. Now, at first, a merchant's neighborhood embedding vectors are fed into a fully-connected neural network and then a mean-pooling operator is applied over them for information aggregation. This is described by the Eqn. 1 given below:

$${k}_{pool}^{} = mean ( \{ σ ( {W}_{pool} {z}_{{m}_{i}}^{k} + b ) , ∀ {m}_{i} ∈ ( m ) \} ) \qquad Eqn . 1$$

Here, the mean is element-wise max operation and a is the Exponential Linear Unit (ELU) activation function.

As described earlier, an unsupervised GNN model (i.e., the conventional GNN model) is generally designed to preserve local neighborhood structural information and the node's feature information. However, as described earlier, high-cardinality category information (high-cardinality sparse categories) which is fed in the form of sparse one-hot encoded features remain partially preserved due to the curse of dimensionality. To overcome this technical problem and to preserve this information, the present disclosure describes the use of two different GNN modules trained differently using different settings of loss functions and input features. In other words, two modified GNN modules (see, 402 and 404) are described herein.

As depicted in FIG. 4, the Loss-Based Category Preservation module 402 (shown as Loss-Based Preservation 402) shifts the sparse categorical features (e.g., C₁, and C₂) from the input (i.e., node 1 feature 408 including numerical features (i.e., F₁, F₂, and F₃)) from the homogeneous entity graph structure 406, hereinafter interchangeably referred to as the homogeneous graph structure 406) to the output space in the form of labels. Further, the Loss-Based Category Preservation 402 module trains a GNN model (i.e., the first machine learning model 216) by adding a supervised loss function (depicted as category preserving supervised loss 410) based on the labels added. As may be understood, this aspect of the first machine learning model 216 allows the direct flow of gradient towards optimizing the categorical features thereby, preserving category information. Since this category information is correlated with other features, this loss function also helps in generating overall better quality embeddings.

Furthermore, the category information is even preserved for any new node for which embedding is required to be generated in the inductive settings using this category preserving supervised loss 410 function. This is because the new node is not an independent and identically distributed (iid) sample, but is connected to the correlated nodes in the homogeneous entity graph structure 406, and optimization over the correlated nodes preserves the category information for the new node as well, even without explicitly passing category information for the new node.

To preserve category information for a given merchant m, a supervised multiclass cross entropy loss is used as defined below by Equation 2:

$${L}_{sup} ( {z}_{m} , y ) = - {\sum }_{l ∈ L} {y}_{l} log ( p ( \hat{y} ( {z}_{m} ) = l ) ) \qquad Eqn . 2$$

Where 1 is a label for merchant m. An example experimentation shows considerable improvement in embedding quality when using the above features as labels in the loss function. For example, one or more of the categorical features corresponding to a merchant including the industry of the merchants, Merchant Category Code (MCC), etc., may be used as a label.

It is understood that since the importance of features is subjective and depends on the task to be performed, there needs to be a way to determine which features are important for performing the required task. In various scenarios, the determination of the set of important features is done based, at least in part, on a set of pre-defined rules. In particular, a team of analysts or an administrator (not shown here for the sake of brevity) of the server system 200 may define this set of predefined rules or logic for either a specific task or a plurality of distinct tasks that may be performed.

In another embodiment, to selectively give more importance to some numerical features (shown as important feature weights Wₚ, Wₙ) over others, based on the given application, a weighted unsupervised loss 412 is used. Here, the weights for a given edge are chosen by using the L2 distance between the important features of the source and destination nodes. More specifically, node pairs (edges) with higher L2 distance are given more weightage in the unsupervised loss function. This preserves the important numerical feature information in the embeddings. As may be understood, when the importance of some features is more or less over others, the weights associated with the plurality of entities in the graph, i.e., the homogeneous entity graph are adjusted within the AI or ML algorithm to define the importance/relevance of that feature. Thus, it may be noted that the new weights may be calculated for each of the plurality of entities based, at least in part, on adjusting weights associated with the set of important features.

For computing the unsupervised loss 414, the graph context loss function used in the previous works brings connected nodes closer to each other in the embedding space while enforcing disparate nodes to have highly distinct embeddings. The unsupervised loss 414 function is defined below using Eqn. 3:

$$L ( {z}_{m} ) = - log ( σ ( {z}_{m}^{T} {z}_{v} ) ) - N \cdot {𝔹}_{{v}_{n} \sim {P}_{n} ( v )} log ( σ ( - {z}_{m}^{T} {z}_{{v}_{n}} ) ) \qquad Eqn . 3$$

where zₘ is the embedding representation of merchant m, v is a merchant that occurs in the neighborhood of m on fixed length random walk, σ is the sigmoid Function, Pₙ is the negative sampling distribution, N is the number of negative samples and zᵥ_{ₙ} is the embedding representation of the negative samples extracted from the distribution. The node embeddings used here are generated by aggregating the neighborhood node embeddings discussed above. This loss function brings connected merchants closer to one another in the embedding space, which means that by designing a homogeneous graph, merchants with cardholder proximity should have similar embeddings.

However, in particular exemplary industrial applications, there may be proximities based on other features which need to be preserved. For example, in this scenario, we try to capture physical proximity based on the L2 distance between the merchant's geo-coordinates (i.e., longitude-latitude) features. To do so, the above loss function is given by Eqn. 3 is modified to give more weightage to merchants with higher physical proximity. In other words, more importance is given to the set of important features. It is noted that the physical distance or physical proximity, i.e., L2 may or may not be important based on the use case or the task. For instance, for a specific task where the performance of nearby merchants needs to be compared, the distances become important. To that end, the present non-limiting implementation describes the calculation of the physical proximity.

In this non-limiting implementation, the above loss function is modified to give more weightage to some specific pairs of merchants as compared to others. This modification is defined by the Eqns. 4-6 given below:

$$L ( {z}_{m} ) = - {w}_{p} log ( σ ( {z}_{m}^{T} {z}_{v} ) ) - {w}_{n} N \cdot {𝔼}_{{v}_{n} \sim {P}_{n} ( v )} log ( σ ( - {z}_{m}^{T} {z}_{{v}_{n}} ) ) \qquad Eqn . 4$$

$${w}_{p} = \frac{1}{σ ( {‖ {f}_{m} - {f}_{v} ‖}^{2} )} \qquad Eqn . 5$$

$${w}_{n} = σ ( {‖ {f}_{m} - {f}_{{v}_{n}} ‖}^{2} ) \qquad Eqn . 6$$

Here, fₘ∈F represent the feature vector corresponding to the selected important numerical features for the merchant m. It should be noted that the weights wₚ and wₙ enforce that merchants with a proximity in the feature space F have similar embeddings while merchants who are distant in F have distinct embeddings.

It is understood that the above-discussed GNN model solves the problem of optimization over sparse features, however, there might be some information in the categories which is not learned using the supervised loss function. This complementary information required complex interactions among the features corresponding to categorical variables. To capture such complex information we shift back categories to the input as one-hot variables and train a GNN encoder using only the sparse-category input features and the unsupervised loss 414 defined in Eqn. 1 within the Feature-Based Category Preservation 404 module. Herein, to train the GNN encoder using only the sparse-category input features, the self-learning attention process (hereinafter, interchangeably referred to and shown as ‘Attention 416’) is applied as shown in FIG. 4. This GNN encoder can also be called sparse category GNN encoder. Lastly, outputs (e.g., E₁ and E₂ respectively) of the Loss-Based Category Preservation 402 module and the Feature-Based Category Preservation 404 module may be concatenated (see, 418) to obtain a final output (e.g., E_{f}420). It is noted that during the training process, the GNN encoders perform back-propagation to preserve the feature and category of the input to optimize themselves. In other words, feature preserving back-propagation and category preserving back-propagating are done to optimize the respective GNN encoders.

As mentioned earlier, it may be noted that the self-learning attention process provides information about how much attention is to be given to a specific point of interest, for example, a feature of a merchant while generating the final embedding representation, i.e., E_{f} 420. In other words, it may be understood that the self-learning attention process or mechanism allows the second machine learning model 218 to focus on the sparse features (i.e., categorical features) and learn from any complex information that was missed earlier by the first machine learning model 216.

In one implementation, to perform entity similarity search when the entity is a merchant at first given a query vector x∈Rⁿ and a set of vectors [yᵢ], the problem of finding similar entities may be solved by finding k nearest neighbors of x in terms of Euclidean distance.

$$L = arg {min}_{i} {‖ x - {y}_{i} ‖}_{2} \qquad Eqn . 7$$

Where, x and yᵢ are the embedding vectors generated via the above-discussed method. We use the Euclidean distance in the embedding space to find out k nearest merchants for a given merchant. This search operation has a complexity of O(n).

As may be understood, in this non-limiting implementation, embeddings of each of the merchants are generated. Similarly, similar merchants are determined based on the Eqn. 7. For instance, if a task for determining ten similar merchants related to a merchant A has to be performed. Then, such ten merchants will be those merchants whose distance in the embeddings space from the merchant A is minimum and this distance is determined using Eqn. 7.

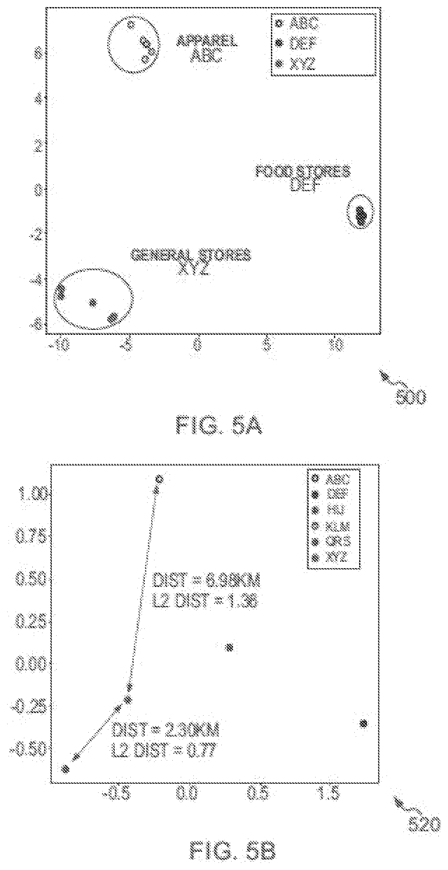

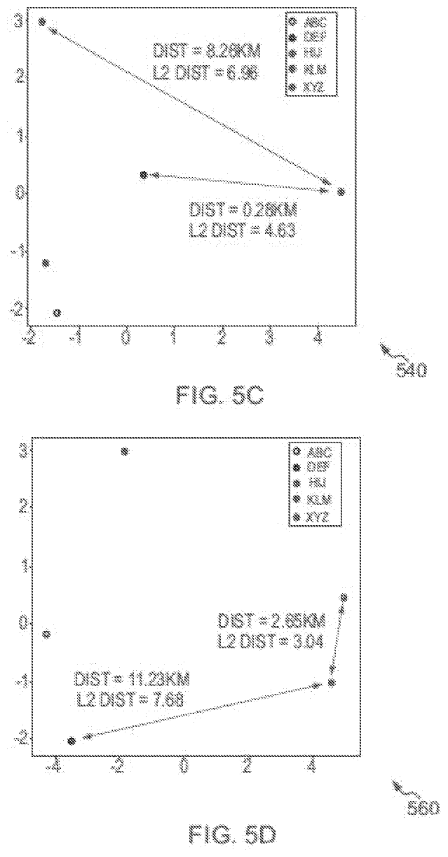

FIGS. 5A, 5B, 5C, and 5D, collectively, illustrate experimental results of various experiments performed in accordance with one or more embodiments of the present disclosure. It may be noted that to better understand the peer set, an experiment may be conducted, wherein three merchants belonging to three separate industries are isolated. In this experiment, the neighbors of these three merchants are analyzed.

Referring to the graph 500 shown in FIG. 5A, it may be understood that a merchant ‘ABC’ belongs to an Apparel Industry, a merchant ‘DEF’ belongs to a Food stores Industry, and a merchant ‘XYZ’ belongs to a General Stores Industry. It may also be understood that the merchants belonging to three different industries are very well separated and close to one another (within the industry) in the vector space as shown by the graph 500 in FIG. 5A.

Further, graphs 520, 540, and 560 are shown in FIGS. 5B-5D indicate a direct correlation between the distance in the real world (as determined by the latitude and longitude) and the L2 norm distance in the vector space, i.e., the merchants that are closer in the physical world are also closer in the vector space and vice-versa. It is noted that additional sample merchants have been assumed for this analysis as well such as merchant HIJ, merchant KLM, and merchant QRS. The corresponding distance (DIST) and L2 distance (L2 DIST) has been shown in graphs 520, 540, and 560 shown in FIGS. 5B-5D.

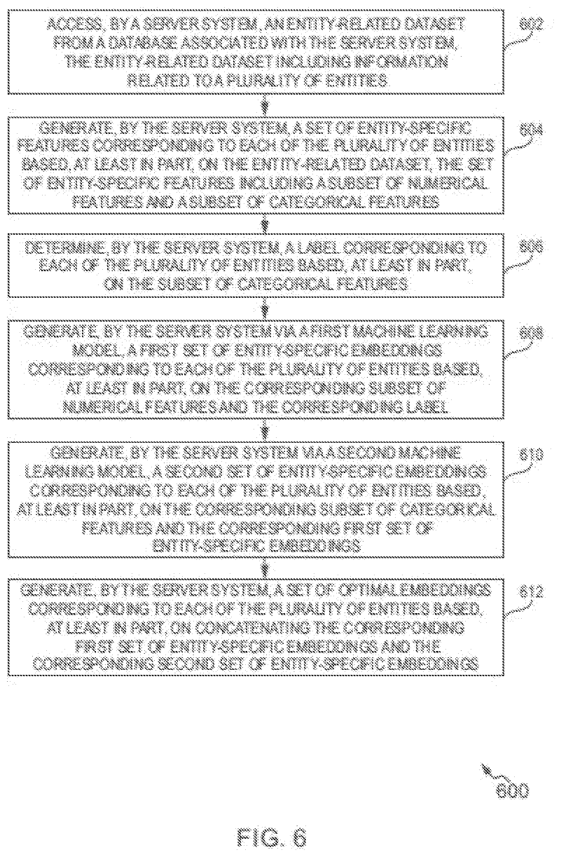

FIG. 6 illustrates a process flow diagram depicting a method 600 for generating a set of optimal embeddings corresponding to each of the plurality of entities, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes accessing, by a server system 200, an entity-related dataset 220 from a database such as database 120 associated with the server system 200, the entity-related dataset 220 including information related to a plurality of entities.

At 604, the method 600 includes generating, by the server system 200, a set of entity-specific features corresponding to each of the plurality of entities based, at least in part, on the entity-related dataset 220, the entity-specific features including a subset of numerical features and a subset of categorical features.

At 606, the method 600 includes determining, by the server system 200, a label corresponding to each of the plurality of entities based, at least in part, on the subset of categorical features.

At 608, the method 600 includes generating, by the server system 200 via a first machine learning model 216, a first set of entity-specific embeddings corresponding to each of the plurality of entities based, at least in part, on the corresponding subset of numerical features and the corresponding label.

At 610, the method 600 includes generating, by the server system 200 via a second machine learning model 218, a second set of entity-specific embeddings corresponding to each of the plurality of entities based, at least in part, on the corresponding subset of categorical features and the corresponding first set of entity-specific embeddings.

At 612, the method 600 includes generating, by the server system 200, a set of optimal embeddings corresponding to each of the plurality of entities based, at least in part, on concatenating the corresponding first set of entity-specific embeddings and the corresponding second set of entity-specific embeddings.

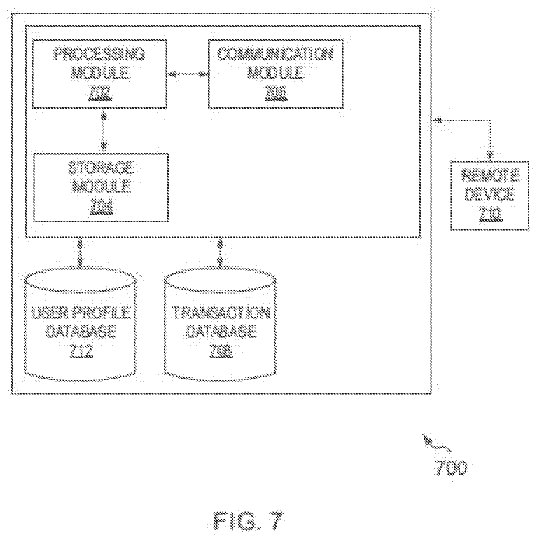

FIG. 7 illustrates a simplified block diagram of the acquirer server 700, in accordance with an embodiment of the present disclosure. The acquirer server 700 is an example of the acquirer server 108 of FIG. 1. The acquirer server 700 is associated with an acquirer bank/acquirer, in which a merchant may have an account. The acquirer server 700 includes a processing module 702 operatively coupled to a storage module 704 and a communication module 706. The components of the acquirer server 700 provided herein may not be exhaustive and the acquirer server 700 may include more or fewer components than those depicted in FIG. 7. Further, two or more components may be embodied in one single component, and/or one component may be configured using multiple sub-components to achieve the desired functionalities. Some components of the acquirer server 700 may be configured using hardware elements, software elements, firmware elements, and/or a combination thereof.

The storage module 704 is configured to store machine-executable instructions to be accessed by the processing module 702. Additionally, the storage module 704 stores information related to, the contact information of the merchant, bank account number, availability of funds in the account, payment card details, transaction details, and/or the like. Further, the storage module 704 is configured to store payment transactions.

In one embodiment, the acquirer server 700 is configured to store profile data (e.g., an account balance, a credit line, details of the merchant such as merchant 106(1), account identification information) in a transaction database 708. The details of the merchant 106(1) may include, but are not limited to, merchant name, age, gender, physical attributes, location, registered contact number, family information, alternate contact number, registered e-mail address, Merchant Category Code (MCC), merchant industry, merchant type, etc.

The processing module 702 is configured to communicate with one or more remote devices such as a remote device 710 using the communication module 706 over a network such as the network 116 of FIG. 1. The examples of the remote device 710 include the server system 102, the payment server 114, the issuer server 110, or other computing systems of the acquirer server 700, and the like. The communication module 706 is capable of facilitating such operative communication with the remote devices and cloud servers using Application Program Interface (API) calls. The communication module 706 is configured to receive a payment transaction request performed by the cardholder 104(1) of the plurality of cardholders 104 via the network 116. The processing module 702 receives payment card information, a payment transaction amount, and cardholder information from the remote device 710 (i.e., the payment server 114). The acquirer server 700 includes a user profile database 712 and the transaction database 708 for storing transaction data. The user profile database 712 may include information of the merchants. The transaction data may include, but is not limited to, transaction attributes, such as transaction amount, source of funds such as bank or credit cards, transaction channel used for loading funds such as POS terminal, transaction velocity features such as count and transaction amount sent in the past x days to a particular user, transaction location information, external data sources, and other internal data to evaluate each transaction.

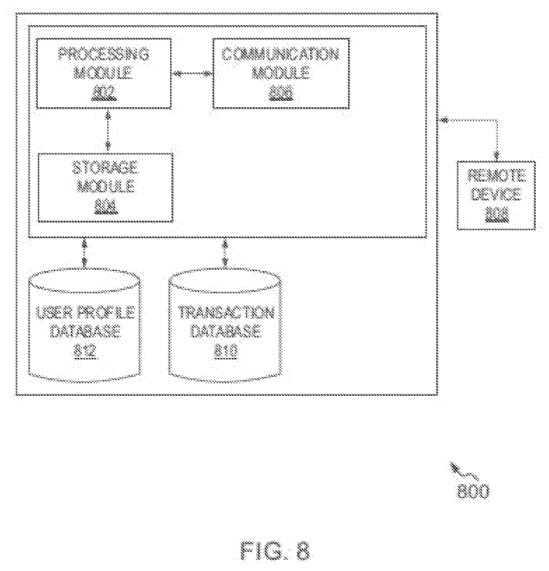

FIG. 8 illustrates a simplified block diagram of the issuer server 800, in accordance with an embodiment of the present disclosure. The issuer server 800 is an example of the issuer server 110 of FIG. 1. The issuer server 800 is associated with an issuer bank/issuer, in which an account holder (e.g., the plurality of cardholders 104(1)-104(N)) may have an account, which provides a payment card (e.g., the payment cards 118(1)-118(N)). The issuer server 800 includes a processing module 802 operatively coupled to a storage module 804 and a communication module 806. The components of the issuer server 800 provided herein may not be exhaustive and the issuer server 800 may include more or fewer components than those depicted in FIG. 8. Further, two or more components may be embodied in one single component, and/or one component may be configured using multiple sub-components to achieve the desired functionalities. Some components of the issuer server 800 may be configured using hardware elements, software elements, firmware elements, and/or a combination thereof.

The storage module 804 is configured to store machine-executable instructions to be accessed by the processing module 802. Additionally, the storage module 804 stores information related to, the contact information of the cardholders (e.g., the plurality of cardholders 104(1)-104(N)), a bank account number, availability of funds in the account, payment card details, transaction details, payment account details, and/or the like. Further, the storage module 804 is configured to store payment transactions.

In one embodiment, the issuer server 800 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 802 is configured to communicate with one or more remote devices such as a remote device 808 using the communication module 806 over a network such as the network 116 of FIG. 1. Examples of the remote device 808 include the server system 200, the payment server 114, the acquirer server 108 or other computing systems of the issuer server 800. The communication module 806 is capable of facilitating such operative communication with the remote devices and cloud servers using API calls. The communication module 806 is configured to receive a payment transaction request performed by an accountholder (e.g., the cardholder 104(1)) via the network 116. The processing module 802 receives payment card information, a payment transaction amount, customer information, and merchant information from the remote device 808 (e.g., the payment server 114). The issuer server 800 includes a transaction database 810 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 800 includes a user profile database 812 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the cardholders 104.

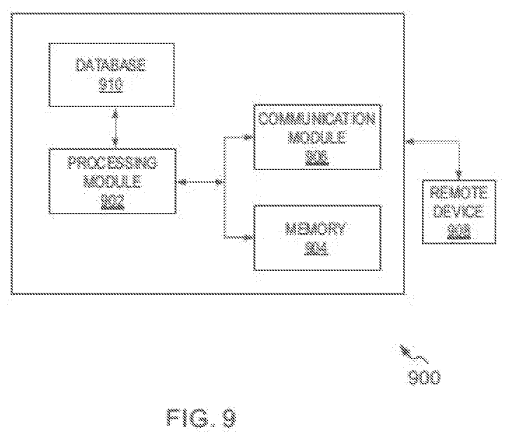

FIG. 9 illustrates a simplified block diagram of the payment server 900, in accordance with an embodiment of the present disclosure. The payment server 900 is an example of the payment server 114 of FIG. 1. The payment server 900 and the server system 200 may use the payment network 112 as a payment interchange network. Examples of payment interchange networks include, but are not limited to, Mastercard® payment system interchange network.

The payment server 900 includes a processing module 902 configured to extract programming instructions from a memory 904 to provide various features of the present disclosure. The components of the payment server 900 provided herein may not be exhaustive and the payment server 900 may include more or fewer components than that depicted in FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication module 906, the processing module 902 receives a request from a remote device 908, such as the issuer server 110, the acquirer server 108, or the server system 102. The request may be a request for conducting the payment transaction. The communication may be achieved through API calls, without loss of generality. The payment server 900 includes a database 910. The database 910 also includes transaction processing data such as issuer ID, country code, acquirer ID, and Merchant Identifier (MID), among others.

When the payment server 900 receives a payment transaction request from the acquirer server 108 or a payment terminal (e.g., IoT device), the payment server 900 may route the payment transaction request to an issuer server (e.g., the issuer server 110). The database 910 stores transaction identifiers for identifying transaction details such as transaction amount, IoT device details, acquirer account information, transaction records, merchant account information, and the like.

In one example embodiment, the acquirer server 108 is configured to send an authorization request message to the payment server 900. The authorization request message includes, but is not limited to, the payment transaction request.

The processing module 902 further sends the payment transaction request to the issuer server 110 for facilitating the payment transactions from the remote device 908. The processing module 902 is further configured to notify the remote device 908 of the transaction status in the form of an authorization response message via the communication module 906. The authorization response message includes, but is not limited to, a payment transaction response received from the issuer server 110. Alternatively, in one embodiment, the processing module 902 is configured to send an authorization response message for declining the payment transaction request, via the communication module 906, to the acquirer server 108. In one embodiment, the processing module 902 executes similar operations performed by the server system 200, however, for the sake of brevity, these operations are not explained herein.

The disclosed method with reference to FIG. 6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, an entity-related dataset from a database associated with the server system, the entity-related dataset comprising information related to a plurality of entities;
generating, by the server system, a set of entity-specific features corresponding to each of the plurality of entities based, at least in part, on the entity-related dataset, the set of entity-specific features comprising a subset of numerical features and a subset of categorical features;
determining, by the server system, a label corresponding to each of the plurality of entities based, at least in part, on the subset of categorical features;
generating, by the server system via a first machine learning model, a first set of entity-specific embeddings corresponding to each of the plurality of entities based, at least in part, on the corresponding subset of numerical features and the corresponding label;
generating, by the server system via a second machine learning model, a second set of entity-specific embeddings corresponding to each of the plurality of entities based, at least in part, on the corresponding subset of categorical features and the corresponding first set of entity-specific embeddings; and
generating, by the server system, a set of optimal embeddings corresponding to each of the plurality of entities based, at least in part, on concatenating the corresponding first set of entity-specific embeddings and the corresponding second set of entity-specific embeddings.

2. The computer-implemented method as claimed in claim 1, wherein generating the first set of entity-specific embeddings, further comprises:
extracting, by the server system, a set of important features from the subset of numerical features based, at least in part, on a task and a set of pre-defined rules;
computing, by the server system, anew set of weights for each of the plurality of entities based, at least in part, on adjusting weights associated with the set of important features; and
generating, by the server system via the first machine learning model, the first set of entity-specific embeddings based, at least in part, on the new set of weights calculated for each of the plurality of entities and the corresponding label.

3. The computer-implemented method as claimed in claim 1, wherein generating the second set of entity-specific embeddings, further comprises:
generating, by the server system, a set of intermediate entity-specific embeddings corresponding to each of the plurality of entities based, at least in part, on the corresponding subset of categorical features; and
determining, by the server system via a self-learning attention process, the second set of entity-specific embeddings corresponding to each of the plurality of entities by updating the corresponding set of intermediate entity-specific embeddings based, at least in part, on the corresponding first set of entity-specific embeddings and the subset of categorical features.

4. The computer-implemented method as claimed in claim 1, further comprising:
generating, by the server system, a homogeneous entity graph based, at least in part, on the entity-related dataset and the set of entity-specific features for each of the plurality of entities, the homogeneous entity graph comprising a plurality of nodes, each of the plurality of nodes corresponding to each of the plurality of entities, wherein each of the plurality of nodes comprises the corresponding set of entity-specific features.

5. The computer-implemented method as claimed in claim 1, further comprising:
generating, by the server system, an entity-specific graph based, at least in part, on the set of optimal embeddings corresponding to each of the plurality of entities.

6. The computer-implemented method as claimed in claim 5, further comprising:
determining, by the server system, a similarity range for an entity from the plurality of entities based, at least in part, on a task; and
generating, by the server system, a peer set for the entity based, at least in part, on the entity-specific graph, and the similarity range, the peer set indicating a set of entities from the entity-specific graph within the similarity range from the entity.

7. The computer-implemented method as claimed in claim 1, wherein the first machine learning model and the second machine learning model are graph neural network (GNN) based machine learning models.

8. The computer-implemented method as claimed in claim 1, wherein the entity-related dataset is a historical transaction dataset, the historical transaction dataset comprising information related to a plurality of historical payment transactions performed between a plurality of cardholders and a plurality of merchants.

9. The computer-implemented method as claimed in claim 1, wherein the plurality of entities is one of a plurality of merchants, a plurality of cardholders, a plurality of issuers, and a plurality of acquirers.

10. The computer-implemented method as claimed in claim 1, wherein the server system is a payment server associated with a payment network.

11. A server system, comprising:
a memory configured to store instructions;
a communication interface; and
a processor in communication with the memory and the communication interface, the processor configured to execute the instructions stored in the memory and thereby cause the server system to perform at least in part to:
access an entity-related dataset from a database associated with the server system, the entity-related dataset comprising information related to a plurality of entities;
generate a set of entity-specific features corresponding to each of the plurality of entities based, at least in part, on the entity-related dataset, the set of entity-specific features comprising a subset of numerical features and a subset of categorical features;
determine a label corresponding to each of the plurality of entities based, at least in part, on the subset of categorical features;
generate via a first machine learning model, a first set of entity-specific embeddings corresponding to each of the plurality of entities based, at least in part, on the corresponding subset of numerical features and the corresponding label;
generate via a second machine learning model, a second set of entity-specific embeddings corresponding to each of the plurality of entities based, at least in part, on the corresponding subset of categorical features and the corresponding first set of entity-specific embeddings; and
generate a set of optimal embeddings corresponding to each of the plurality of entities based, at least in part, on concatenating the corresponding first set of entity-specific embeddings and the corresponding second set of entity-specific embeddings.

12. The server system as claimed in claim 11, wherein for generating the first set of entity-specific embeddings, the server system is further caused, at least in part, to:
extract a set of important features from the subset of numerical features based, at least in part, on a task;
compute a new set of weights for each of the plurality of entities based, at least in part, on adjusting weights associated with the set of important features; and
generate via the first machine learning model, the first set of entity-specific embeddings based, at least in part, on the corresponding new set of weights calculated for each of the plurality of entities and the corresponding label.

13. The server system as claimed in claim 11, wherein for generating the second set of entity-specific embeddings, the server system is further caused, at least in part, to:
generate a set of intermediate entity-specific embeddings corresponding to each of the plurality of entities based, at least in part, on the corresponding subset of categorical features; and
determine via a self-learning attention process, the second set of entity-specific embeddings corresponding to each of the plurality of entities by updating the corresponding set of intermediate entity-specific embeddings based, at least in part, on the corresponding first set of entity-specific embeddings and the subset of categorical features.

14. The server system as claimed in claim 11, wherein the server system is further caused, at least in part, to:
generate a homogeneous entity graph based, at least in part, on the entity-related dataset and the set of entity-specific features for each of the plurality of entities, the homogeneous entity graph comprising a plurality of nodes, each of the plurality of nodes corresponding to each of the plurality of entities, wherein each of the plurality of nodes comprises the corresponding set of entity-specific features.

15. The server system as claimed in claim 11, wherein the server system is further caused, at least in part, to:
generate an entity-specific graph based, at least in part, on the set of optimal embeddings corresponding to each of the plurality of entities.
determine a similarity range for an entity from the plurality of entities based, at least in part, on a task; and
generate a peer set for the entity based, at least in part, on the entity-specific graph, and the similarity range, the peer set indicating a set of entities from the entity-specific graph within the similarity range from the entity.

16. The server system as claimed in claim 11, wherein the first machine learning model and the second machine learning model are graph neural network (GNN) based machine learning models.

17. The server system as claimed in claim 11, wherein the entity-related dataset is a historical transaction dataset, the historical transaction dataset comprising information related to a plurality of historical payment transactions performed between a plurality of cardholders and a plurality of merchants.

18. The server system as claimed in claim 11, wherein the plurality of entities is one of a plurality of merchants, a plurality of cardholders, a plurality of issuers, and a plurality of acquirers.

19. A non-transitory computer-readable storage medium comprising computer-executable instructions that, when executed by at least a processor of a server system, cause the server system to perform a method comprising:
accessing an entity-related dataset from a database associated with the server system, the entity-related dataset comprising information related to a plurality of entities;
generating a set of entity-specific features corresponding to each of the plurality of entities based, at least in part, on the entity-related dataset, the set of entity-specific features comprising a subset of numerical features and a subset of categorical features;
determining a label corresponding to each of the plurality of entities based, at least in part, on the subset of categorical features;
generating via a first machine learning model, a first set of entity-specific embeddings corresponding to each of the plurality of entities based, at least in part, on the corresponding subset of numerical features and the corresponding label;
generating via a second machine learning model, a second set of entity-specific embeddings corresponding to each of the plurality of entities based, at least in part, on the corresponding subset of categorical features and the corresponding first set of entity-specific embeddings; and
generating a set of optimal embeddings corresponding to each of the plurality of entities based, at least in part, on concatenating the corresponding first set of entity-specific embeddings and the corresponding second set of entity-specific embeddings.

20. The non-transitory computer-readable storage medium as claimed in claim 19, wherein for generating the first set of entity-specific embeddings, the method further comprises:
extracting a set of important features from the subset of numerical features based, at least in part, on a task;
compute a new set of weights for each of the plurality of entities based, at least in part, on adjusting weights associated with the set of important features; and
generating via the first machine learning model, the first set of entity-specific embeddings based, at least in part, on the corresponding new set of weights calculated for each of the plurality of entities and the corresponding label.
